(19) United States
(12) Patent Application Publication
(10) Pub. No.: US 2008/0050666 A1
(43) Pub. Date: Feb. 28, 2008

(54) Electrophotographic photoconductor and image forming apparatus

(76) Inventors: Junichiro Otsubo, Osaka (JP); Jun Azuma, Osaka (JP); Keiji Maruo, Osaka (JP); Yoshio Inagaki, Osaka (JP)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/891,861

(22) Filed: Aug. 14, 2007

(30) Foreign Application Priority Data
Aug. 25, 2006 (JP) 2006-229161

(51) Int. Cl. G03G 15/04; G03G 21/16

(52) U.S. Cl. 430/65; 399/111

(57) ABSTRACT

To provide an electrophotographic photoconductor which can effectively prevent the generation of exposure memory and the increase in residual potential by easily adjusting the electroconductivity in an intermediate layer, and an image forming apparatus using the electrophotographic photoconductor. An electrophotographic photoconductor comprising a base body, and an intermediate layer containing a titanium oxide and a binding resin and a photosensitive layer which are arranged on the base body, and an image forming apparatus using the same, wherein an average primary particle diameter of the titanium oxide is set to a value within the range of 5 to 30 nm, a thickness of the intermediate layer set to a value within the range of 0.5 to 3 μm, and the volume resistivity in the intermediate layer is set to a value within the range of 1×10¹⁰ to 5×10¹³ Ω·cm.

### BACKGROUND OF THE INVENTION

1. Field of the Invention

The present invention relates to an electrophotographic photoconductor and an image forming apparatus. Particularly, the invention relates to an electrophotographic photoconductor which can effectively prevent the generation of exposure memory and the increase in residual potential even when an intermediate layer is formed, and to an image forming apparatus using the electrophotographic photoconductor.

2. Description of the Related Art

Generally, the organic photoconductors have recently been used widely as electrophotographic photoconductors for use in the electrophotographic devices such as copying machines and laser printers because there are requests for low cost, low environmental polluting property, and the like. In such organic photoconductors, an approach is known which comprises forming an intermediate layer between a photosensitive layer and a base body for the purposes of prevention of charge injection from a base body, elimination of image defects caused by defects in a base body, improvement in adhesion between a photosensitive layer and a base body, and improvement in charging property.

However, when such an intermediate layer is formed, there is a problem that it becomes impossible to allow charges generated in the photosensitive layer to dissipate into the base body well.

As a result, there has been a problem that residual charges are generated easily in the photosensitive layer, resulting in generation of exposure memories. Further, the decrease in moving the efficiency of charges in the photosensitive layer leads to the generation of carrier trap in the photosensitive layer or increase in charges accumulated in the interface between the intermediate layer and the photosensitive layer. In such occasions, when image formation is repeated, there arises a problem that the residual potential increases.

In order to solve such problems, an approach of controlling the electroconductivity of an intermediate layer by dispersing particles of a metal oxide such as a titanium oxide into the intermediate layer has been proposed (see, for example, patent document 1 and patent document 2).

More specifically, the patent document 1 proposes an electrophotographic photoconductor comprising an intermediate layer which contains electroconducted metal compound particles and which has a volume resistivity of 1×10¹⁰ to 1×10¹³ Ω·cm.

The patent document 2 proposes an electrophotographic photoconductor comprising an intermediate layer having nonlinear property characterized in that the volume resistivity in an arbitrary electric field in the charging direction is 5 times or more, the volume resistivity in an electric field as strong as 5 times the former one.

However, the electrophotographic photoconductor described in the patent document 1 is unfortunately difficult to be produced because the metal compound particles dispersed into the intermediate layer must be covered with electroconductive materials such as carbon black and palladium.

In the electrophotographic photoconductor described in the patent document 2, no considerations are given to the thickness of the intermediate layer or to the dispersibility of the metal oxide to be dispersed into the intermediate layer though the volume resistivity of the intermediate layer is considered. Therefore, there is a problem that it is difficult to stably control the electroconductivity as the entire portion of the intermediate layer.

### [Patent document 1] JP-A-2004-302462 (Claims)

### [Patent document 2] JP-A-2002-99107 (Claims)

### SUMMARY OF THE INVENTION

Then, the present inventors earnestly studied in view of the problems mentioned above. As the result, they have found that it is possible to effectively prevent the generation of exposure memory and the increase in residual potential through easy adjustment of the electroconductivity in an intermediate layer by rendering the average primary particle diameter of a titanium oxide dispersed in the intermediate layer, the thickness of the intermediate layer and the volume resistivity in the intermediate layer within predetermined ranges, respectively.

An object of the present invention is to provide an electrophotographic photoconductor which can effectively prevent the generation of exposure memory and the increase in residual potential by easily setting the electroconductivity in an intermediate layer, and an image forming apparatus using the electrophotographic photoconductor.

According to one aspect of the present invention, there is provided an electrophotographic photoconductor including: a base body and an intermediate layer containing a titanium oxide and a binding resin and a photosensitive layer which are arranged on the base body, wherein the titanium oxide has an average primary particle diameter within the range of 5 to 30 nm, the intermediate layer has a thickness within the range of 0.5 to 3 μm, and the volume resistivity in the intermediate layer is a value within the range of 1×10¹⁰ to 5×10¹³ Ω·cm. This can solve the problems. By setting the average primary particle diameter of a titanium oxide to the predetermined range, the dispersibility in an intermediate layer is improved and it is possible to make the electroconductivity of an intermediate layer having a uniform thickness.

Further, by setting the thickness and the volume resistivity of the intermediate layer to the predetermined ranges, the electroconductivity of the intermediate layer can be controlled to an appropriate range.

It is therefore possible to set the electroconductivity in the intermediate layer and to effectively prevent the generation of exposure memory and the increase in residual potential.

In constituting the electrophotographic photoconductor of the present invention, it is preferable to set a value (ΔL value) obtained by subtracting an L value measured by using the base body alone from an L value of the intermediate layer measured in a state where the layer is arranged on the base body (a parameter value measured with the calorimeter in accordance with JIS Z-8722) to a value within the range of −5.0 to 0.

This constitution makes it possible to check the dispersibility of the titanium oxide into the intermediate layer easily.

It is therefore possible to control and prevent the electroconductivity in the intermediate layer more easily and certainly.

In constituting the electrophotographic photoconductor of the invention, it is preferable to set the additional amount of the titanium oxide to a value within the range of 150 to 350 parts by weight based on 100 parts by weight of the binding resin.

By adopting such a constitution, it becomes easy to set the volume resistivity of the intermediate layer to the predetermined range and it is possible to improve the dispersibility of a titanium oxide.

In constituting the electrophotographic photoconductor of the invention, it is preferable that the titanium oxide has been subjected to surface treatment with alumina, silica and an organosilicon compound.

Such a constitution makes it possible to improve the dispersibility of the titanium oxide in the intermediate layer and to set the electroconductivity of the intermediate layer to a desirable range.

In constituting the electrophotographic photoconductor of the invention, it is preferable that the surface treatment amount with the alumina and silica would be set to a value within the range of 1 to 30 parts by weight based on 100 parts by weight of the titanium oxide, and that the surface treatment amount with the organosilicon compound would be set to a value within the range of 1 to 15 parts by weight based on 100 parts by weight of the binding resin.

By adopting such a constitution, it is possible to further improve the dispersibility of a titanium oxide in the intermediate layer, and to set the electroconductivity of the intermediate layer to a value within a more desirable range.

The surface treatment amount with alumina and silica means the total treatment amount of alumina and silica.

In constituting the electrophotographic photoconductor of the invention, two or more kinds of a titanium oxide are preferably included as a titanium oxide.

This constitution enables the electroconductivity of the intermediate layer to be controlled more easily.

In constituting the electrophotographic photoconductor of the invention, the binding resin is preferably a polyamide resin.

Such a constitution makes it possible not only to improve the adhesion of the intermediate layer between the base body and the photosensitive layer, but also to improve the dispersibility of the titanium oxide.

In constituting the electrophotographic photoconductor of the invention, it is preferable to set the number average molecular weight of the binding resin to a value within the range of 1,000 to 50,000.

By adopting such a constitution, it is possible not only to form the intermediate layer in a more uniform thickness, but also to further improve the dispersibility of a titanium oxide.

In constituting the electrophotographic photoconductor of the invention, the coating liquid for forming the intermediate layer is preferably obtained by a production method including the following steps (A) and (B):

(A) a step of adding a titanium oxide to a binding resin solution in which the binding resin in an amount of 31 to 65% by weight of the total quantity of all the binding resin which constitutes the intermediate layer is dissolved, thereby forming a primary dispersion liquid; and

(B) a step of dissolving a binding resin in an amount of 35 to 69% by weight of the total quantity of all the binding resin in the primary dispersing liquid, thereby forming a coating liquid for an intermediate layer.

This constitution enables to further improve the dispersibility of a titanium oxide in the intermediate layer.

Another aspect of the present invention is an image forming apparatus including one of the electrophotographic photoconductors described above, wherein a charging means, an exposure means, a developing means and a transfer means are arranged around the electrophotographic photoconductor.

The image forming apparatus of the invention is capable of stably forming good quality images in which the generation of a memory image is repressed because the apparatus has an electrophotographic photoconductor having an intermediate layer satisfying the predetermined conditions.

In addition, even when image formation is performed repeatedly, the increase in residual potential is prevented, thereby enabling clear images to be formed at a high speed.

In forming the image forming apparatus of the invention, the image forming apparatus is preferably an electricity neutralizing means less image forming apparatus in which the electricity neutralizing means by light is omitted.

Even in the case of adopting such a constitution, the image forming apparatus of the invention can stably form good quality images in which the generation of a memory image is prevented.

It is therefore possible to contribute to making an image forming apparatus compact or reducing the cost thereof.

### BRIEF DESCRIPTION OF THE DRAWINGS

FIGS. 1A and 1B are diagrams for illustrating the constitutional outline of a multilayer-type electrophotographic photoconductor of the present invention;

FIG. 2 is a graph for illustrating the relationship between an average primary particle diameter of a titanium oxide and a memory potential;

FIG. 3 is a graph for illustrating the relationship between a volume resistivity in an intermediate layer and the memory potential;

FIG. 4 is a graph for illustrating the relationship between the volume resistivity in the intermediate layer and a residual potential;

FIG. 5 is a graph for illustrating the relationship between a thickness of the intermediate layer and the residual potential;

FIGS. 6A and 6B are diagrams for illustrating a method for measuring a ΔL value in the intermediate layer;

FIG. 7 is a graph for illustrating the relationship between the ΔL value (dispersibility) and the exposure memory;

FIGS. 8A and 8B are diagrams for illustrating the constitution outline of a monolayer-type electrophotographic photoconductor of the present invention; and

FIG. 9 is a diagram for illustrating the constitutional outline of an image forming apparatus of the present invention.

### DESCRIPTION OF THE PREFERRED EMBODIMENTS

### First Embodiment

A first embodiment of the present invention is an electrophotographic photoconductor including a base body, and an intermediate layer containing a titanium oxide and a binding resin and a photosensitive layer which are arranged on the base body, wherein the an average primary particle diameter of the titanium oxide is set to a value within the range of 5 to 30 nm, a thickness of the intermediate layer is set to a value within the range of 0.5 to 3 μm, and the volume resistivity in the intermediate layer is set to a value within the range of 1×10¹⁰ to 5×10¹³ Ω·cm.

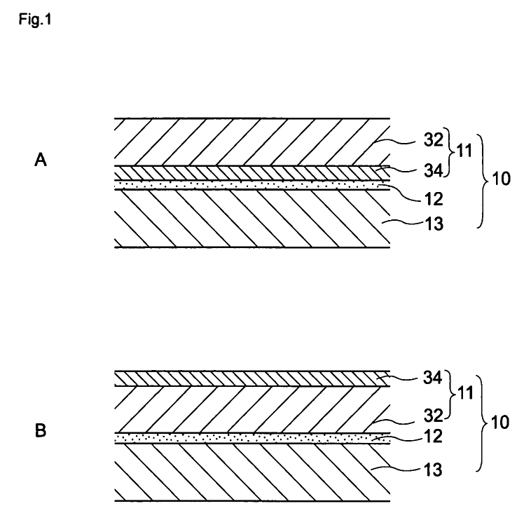

Hereafter, the electrophotographic photoconductor of the first embodiment will be described by separating it into its constitutional features mainly by taking a multilayer-type electrophotographic photoconductor 10 having a supporting base body 13, an intermediate layer 12, a charge generating layer 34 and a charge transfer layer 32 as an example as shown in FIGS. 1A and 1B.

### 1. Base Body

As base body 13 shown in FIG. 1, various materials having electroconductivity can be used. Examples thereof include base bodies made of metal such as iron, aluminum, copper, tin, platinum, silver, vanadium, molybdenum, chromium, cadmium, titanium, nickel, palladium, indium, stainless steel and brass; base bodies made of plastic materials with the foregoing metals vapor-deposited or laminated; and glass base bodies covered with an aluminum iodide, alumite, a tin oxide, an indium oxide, or the like.

That is, it is required only that the base body itself has electroconductivity or that the surface of the base body has electroconductivity. The base body is preferably one having sufficient mechanical strength when being used.

The base body may be in any form, such as a sheet form and a drum form, depending on the structure of an image forming apparatus to be used.

### 2. Intermediate Layer

Another feature is that the intermediate layer 12 containing a binding resin and a titanium oxide is characterized by arranging on the base body 13 as illustrated in FIG. 1. The intermediate layer will be described below by separating it into the binding resin, the titanium oxide, and the like.

### (1) Binding Resin

### (1)-1 Kind

As the binding resin, it is preferable to use at least one resin selected from the group consisting of a polyamide resin, a polyvinyl alcohol resin, a polyvinyl butyral resin, a polyvinyl formal resin, a vinyl acetate resin, a phenoxy resin, a polyester resin and an acrylic resin.

Among the binder resins shown above, use of a polyamide resin is particularly preferred.

The reason for this is that use of a polyamide resin as the binding resin makes it possible not only to improve the adhesion of the intermediate layer to the base body and the photosensitive layer, but also to improve the dispersibility of the titanium oxide.

In other words, that is because a polyamide resin exerts excellent adhesion to the base body and therefore it is possible to effectively inhibit generation of image defects caused by defects in the surface of the base body.

Further, even under high-temperature and high-humidity conditions, the intermediate layer is bound stably to the base body and to the photosensitive layer in each interface. This makes it possible to prevent the occurrence of peeling in the interfaces, thereby effectively preventing the occurrence of fogging in formed images.

Furthermore, it is possible to form an intermediate layer having uniform electroconductivity through improvement in the dispersibility of the titanium oxide contained in the resin.

As a polyamide resin, it is preferable to use an alcohol-soluble polyamide resin because it exhibits excellent solubility in a solvent. Specific examples thereof preferably include a so-called copolymer nylon obtained by copolymerizing nylon 6, nylon 66, nylon 610, nylon 11, nylon 12 or the like, and a so-called modified nylon obtained by chemically modifying nylon, such as N-alkoxymethyl-modified nylon, N-alkoxyethylnylon or the like.

### (1)-2 Number Average Molecular Weight

It is preferable to set a number average molecular weight of the binding resin to a value within the range of 1,000 to 50,000.

This is because when the number average molecular weight of the binding resin is set to a value within that range, it is possible not only to form the intermediate layer in a more uniform thickness, but also to further improve the dispersibility of the titanium oxide.

In other words, that is because when the number average molecular weight of the binding resin is below 1,000, the viscosity of a coating liquid for forming the intermediate layer may decrease greatly, thereby becoming difficult to form an intermediate layer with a uniform thickness or the mechanical strength, film formability, or adhesiveness may decrease remarkably. On the other hand, that is also because when the number average molecular weight of the binding resin is above 50,000, the viscosity of a coating liquid for forming the intermediate layer will increase greatly, thereby becoming difficult to control the thickness of an intermediate layer or the electroconductivity may decrease remarkably.

For such reasons, it is more preferably to set the number average molecular weight of the binding resin to a value within the range of 2,000 to 30,000, and even more preferable to set to a value within the range of 5,000 to 15,000.

The number average molecular weight of the binding resin may be measured as a molecular weight calibrated with polystyrene by use of gel permeation chromatography (GPC) or, when the binding resin is a condensation resin, it may also be determined by calculation from the degree of condensation thereof.

Also when the viscosity average molecular weight is set to the above-mentioned range instead of the number average molecular weight, a similar effect can be obtained.

### (1)-3 Viscosity

It is preferable to set the solution viscosity (in an ethanol/toluene=1/1 solvent, 5% by weight concentration, 25° C.) of the binding resin to a value within the range of 10 to 200 mPa·sec.

This is because when the solution viscosity of the binding resin is below 10 mPa·sec, a great difference in thickness of the intermediate layer may arise due to decrease in film formability of the intermediate layer, the mechanical strength or adhesion of the intermediate layer may decrease remarkably, or the dispersibility of pigment or the like may decrease, while on the other hand, when the solution viscosity of the binding resin is above 200 mPa·sec, it may become difficult to form an intermediate layer with a uniform thickness.

The solution viscosity (in an ethanol/toluene=1/1 solvent, it is more preferable to set 5% by weight concentration, 25° C.) of the binding resin to a value within the range of 30 to 180 mPa·sec, and even more preferably to a value within the range of 50 to 150 mPa·sec.

### (1)-4 Quantity of Hydroxyl Groups

When the binding resin is a film-forming resin having hydroxyl groups, it is preferable to set the quantity of hydroxyl groups to a value within the range of 10 to 40 mol %.

The reason is that when the quantity of hydroxyl groups of the film-forming resin having hydroxyl groups is below 10 mol %, the mechanical strength, film formability or adhesion of the intermediate layer may decrease remarkably or, in addition, the dispersibility of the titanium oxide may decrease. That is also because when quantity of hydroxyl groups of the film-forming resin having hydroxyl groups is above 40 mol %, gelation may occur easily or it may become difficult to form an intermediate layer which is uniform in thickness.

Therefore, when using a film-forming resin having hydroxyl groups as the binding resin, it is more preferable to set the quantity of hydroxyl groups to a value within the range of 20 to 38 mol %, and even more preferable to set a value within the range of 25 to 35 mol %.

Examples of such a film-forming resin having hydroxyl groups include a polyvinyl butyral resin and a polyvinyl formal resin.

### (2) Titanium Oxide

Another feature is that the intermediate layer contains a titanium oxide together with the binding resin described above.

The reason is that the titanium oxide has a predetermined electroconductivity and, therefore, it is possible to impart a predetermined electroconductivity to the intermediate layer by dispersing such the titanium oxide into the intermediate layer.

In other words, that is because when the electroconductivity of the intermediate layer becomes too low, it may become difficult for charges generated in the photosensitive layer to move to the base body and, as a result, exposure memory or increase in residual potential may be caused, while on the other hand, when the electroconductivity of the intermediate layer becomes too high, charges may be injected from the base body or the charging property may deteriorate.

Therefore, in order to adjust the electroconductivity of the intermediate layer to a desirable range, it is necessary to change the additional amount, average primary particle diameter, surface treatment and the like of the titanium oxide. Each of the requirements will be disclosed below.

Regarding the titanium oxide, either crystalline one or noncrystalline one may be used. When the titanium oxide is crystalline, any crystalline form selected from anatase form, rutile form and brookite form may be available, and use of a rutile type titanium oxide is preferred.

### (2)-1 Average Primary Particle Diameter

It is characterized in that the average primary particle diameter (number average primary particle diameter, and so forth) of a titanium oxide is set to a value within the range of 5 to 30 nm.

The reason is that by setting the average primary particle diameter of a titanium oxide to a value within the range of 5 to 30 nm, the dispersibility in the intermediate layer becomes good, thereby making the electroconductivity of the intermediate layer uniform.

More specifically, that is because when the average primary particle diameter of a titanium oxide is below 5 nm, it may become difficult to produce such the titanium oxide particles precisely and, in addition, the particles may aggregate easily, while on the other hand, when the average primary particle diameter of a titanium oxide becomes above 30 nm, the dispersibility in the intermediate layer may decrease to make the electroconductivity in the intermediate layer nonuniform, with the result that residual charges may be generated easily in the photosensitive layer and it may become difficult to effectively control exposure memories.

For such reasons, it is more desirable to set the average primary particle diameter of a titanium oxide to a value within the range of 10 to 20 nm, and even more desirably to a value within the range of 12 to 18 nm.

The average primary particle diameter of a titanium oxide can be measured by using a combination of an electron micrograph and an image processing device.

More specifically, for example, after taking a photograph of a titanium oxide with a magnification of 30,000 by a scanning electron microscope of the titanium oxide, the photograph is processed with a CCD and the image data is captured into a personal computer. Subsequently, for example, the number average particle diameter (major axis length) of arbitrary 100 titanium oxide particles found in the image is determined using general image processing software, such as WIN ROOF manufactured by Mitani Corporation, and it may be considered as the average primary particle diameter of the titanium oxide.

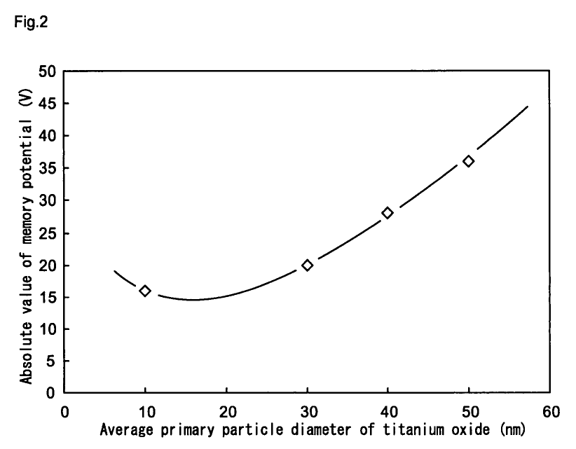

Next, the relationship between the average primary particle diameter of a titanium oxide and a memory potential in an electrophotographic photoconductor having an intermediate layer containing the titanium oxide dispersed therein will be described with reference to FIG. 2.

In FIG. 2 shown is a characteristic curve (produced under conditions: content of a titanium oxide based on 100 parts by weight of the binder resin of the intermediate layer=300 parts by weight; thickness of the intermediate layer=2 μm) in which an average primary particle diameter (nm) of a titanium oxide is the abscissa and an absolute value of the memory potential (V) in the electrophotographic photoconductor having an intermediate layer containing such the titanium oxide is the ordinate. The constitution of the electrophotographic photoconductor used and the method of measuring a memory potential are disclosed in Examples described below.

As shown by the characteristic curve, when the average primary particle diameter (nm) of a titanium oxide is 30 nm or less, the absolute value (V) of the memory potential is maintained stably at a low value near 15 V. When the average primary particle diameter (nm) of a titanium oxide is a value over 30 nm, on the other hand, the absolute value (V) of the memory potential increases rapidly with increase in the average primary particle diameter. When the average primary particle diameter (nm) of a titanium oxide is a value of 50 nm, the absolute value (V) of the memory potential increases to about 35 V.

It is therefore found that the memory potential can be stably controlled to a low value by setting the average primary particle diameter of a titanium oxide to 30 nm or less.

### (2)-2 Additional Amount

It is more preferable to set the additional amount of the titanium oxide to a value within the range of 150 to 350 parts by weight based on 100 parts by weight of the binding resin.

This is because by setting the additional amount of the titanium oxide to such a range, it becomes easy to adjust the volume resistivity of the intermediate layer to the predetermined range and it is possible to improve the dispersibility of the titanium oxide.

In other words, that is because when the additional amount of the titanium oxide is below 150 parts by weight based on 100 parts by weight of the binding resin, it may become difficult to fully improve the electroconductivity of the intermediate layer, while on the other hand, when the additional amount of the titanium oxide becomes a value exceeding 350 parts by weight based on 100 parts by weight of the binding resin, the electroconductivity of the intermediate layer may become too high or the dispersibility of the titanium oxide may deteriorate.

For such reasons, it is more desirable to set the additional amount of a titanium oxide to a value within the range of 180 to 320 parts by weight, and even more desirably to a value within the range of 200 to 300 parts by weight based on 100 parts by weight of the binding resin.

When two or more kinds of a titanium oxide are used together, the additional amount of a titanium oxide means the total quantity of them as disclosed in the next section.

It is also preferable that another titanium oxide different in average primary particle diameter, surface treatment, or the like is further contained.

The reason is that use of two or more kinds of a titanium oxide together enables the electroconductivity of the intermediate layer to be controlled more easily.

In other words, that is because changing the mixing ratio of the two or more kinds of the titanium oxide makes it easy to adjust the electroconductivity of the intermediate layer at will.

### (2)-3 Surface Treatment

Preferably, the titanium oxide has been subjected to surface treatment with alumina, silica and an organosilicon compound.

The reason is that applying such surface treatment makes it possible to further improve the dispersibility of the titanium oxide in the intermediate layer and also to adjust the electroconductivity of the intermediate layer to a desirable range.

In other words, that is because by applying surface treatment with alumina (Al₂O₃) and silica (SiO₂) to titanium oxide, it is possible to improve the basic dispersibility of the titanium oxide in the intermediate layer.

That is also because by applying surface treatment with alumina and silica to titanium oxide, the surface treatment amount with an organosilicon compound disclosed later can be easily controlled.

That is also because by applying surface treatment with an organosilicon compound to titanium oxide, it is possible not only to further improve the dispersibility of the titanium oxide, but also to easily control the electroconductivity of the titanium oxide by changing the surface treatment amount.

Examples of organosilicon compounds to be used suitably include alkylsilane compounds, alkoxysilane compounds, vinyl group-containing silane compounds, mercapto group-containing silane compounds, amino group-containing silane compounds, or polysiloxane compounds, which are polycondensates of the foregoing compounds. More specifically, siloxane compounds, such as methylhydrogenpolysiloxane and dimethyl polysiloxane, are preferred. In particular, methylhydrogenpolysiloxane is preferred.

It is preferable to set the additional amount of alumina and silica to a value within the range of 1 to 30 parts by weight, and more desirably to a value within the range of 5 to 20 parts by weight based on 100 parts by weight of the titanium oxide. It is preferable to set the additional amount of an organosilicon compound to a value within the range of 1 to 15 parts by weight, and more desirably to a value within the range of 5 to 10 parts by weight based on 100 parts by weight of the titanium oxide.

It is known that the above-mentioned surface treatment with an organosilicon compound is applied to titanium oxide, whereby the adhesive strengths of the surface-treated intermediate layer containing the titanium oxide to the base body and to the photosensitive layer are improved.

Such effects are conceivably derived from improvement in cohesion force of a polyamide resin caused by interaction between the organosilicon compound and the polyamide resin and also are conceivably derived from the organosilicon compound's exertion of an effect of modifying the surface in the intermediate layer like a primer.

Anyway, by applying surface treatment with an organosilicon compound to the titanium oxide, it is possible not only to control the dispersibility of the titanium oxide and the electroconductivity, but also to control the adhesive strengths of the intermediate layer to the base body and to the photosensitive layer.

### (3) Additives

It is also preferable to add various additives other than the titanium oxide (namely, organic fine powder or inorganic fine powder) for the purpose of producing light scattering to prevent the generation of interference fringes and the purpose of improving the dispersibility or the like.

Particularly preferable additives include inorganic pigments including white pigments such as zinc oxide, zinc flower, zinc sulfide, lead white and lithopone, and extenders such as alumina, calcium carbonate and barium sulfate; and fluororesin particles; benzoguanamine resin particles; and styrene resin particles.

When adding an additive such as a fine powder, It is preferable to set the particle diameter to a value within the range of 0.01 to 3 μm. This is because when the particle diameter is too great, the intermediate layer may have coarse irregularities, or electrically nonuniform portions may be formed, or an image quality defect may be caused easily, while on the other hand, when the particle diameter is too small, a sufficient light scattering effect may not be obtained.

When adding an additive such as a fine powder, it is preferable to set the additional amount thereof to a value within the range of 1 to 70% of by weight, and more preferably within the range of 5 to 60% by weight in weight ration based on the solid in the intermediate layer.

It is also desirable to add a charge transfer agent to the intermediate layer. This is because adding a charge transfer agent enables to cause charges generated in the photosensitive layer to move to the base body, thereby showing stable electric characteristics.

As such charge transfer agents, conventionally known various compounds may be used.

### (4) Volume Resistivity

It is characterized in that the volume resistivity in the intermediate layer is set to a value within the range of 1×10¹⁰ to 5×10¹³ Ω·cm.

The reason is that setting the volume resistivity in the intermediate layer to the predetermined range allows the electroconductivity of the overall intermediate layer to be set to a preferable range in association with the thickness of the intermediate layer disclosed later.

In other words, that is because when the volume resistivity in the intermediate layer is below 1×10¹⁰ Ω·cm, the insulating property in the intermediate layer is decreased excessively and, therefore, even when the thickness of the intermediate layer is increased, it may become difficult to maintain predetermined charging properties. As a result, the influence of residual charges in the photosensitive layer may relatively increase and exposure memories may be generated easily. On the other hand, that is because when the volume resistivity in the intermediate layer is above 5×10¹³ Ω·cm, the electroconductivity in the intermediate layer is decreased excessively and, therefore, even when the thickness of the intermediate layer is reduced, it may become difficult for charges generated in the photosensitive layer to escape to the base body. As a result, the residual potential may increase through carrier trap in the photosensitive layer or through increase in charges accumulated in the interface between the intermediate layer and the photosensitive layer, or exposure memories may be generated easily due to the residual charge itself.

For such reasons, it is more preferable to set the volume resistivity in the intermediate layer to a value within the range of 2×10¹⁰ to 3×10¹³ Ω·cm, and even more desirably to a value within the range of 1×10¹¹ to 5×10¹² Ω·cm.

The method of measuring the volume resistivity in the intermediate layer is disclosed specifically in Examples shown later.

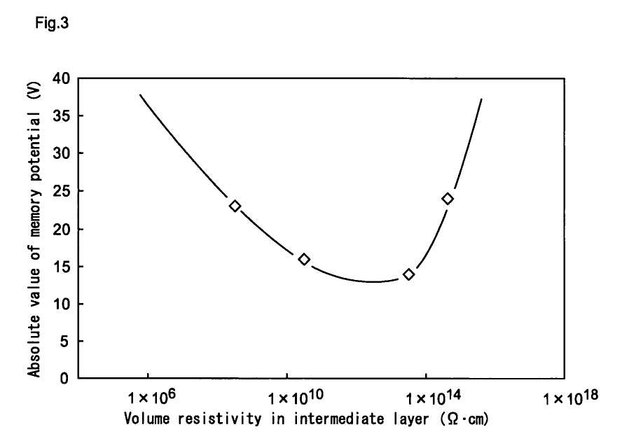

Next, with reference to FIG. 3, description will be given to the relationship between the volume resistivity in an intermediate layer and the memory potential in an electrophotographic photoconductor having the intermediate layer.

In FIG. 3 shown is a characteristic curve (produced under conditions: average primary particle diameter of a titanium oxide in the intermediate layer=10 nm; thickness of the intermediate layer=2 μm) in which the volume resistivity (Ω·cm) in the intermediate layer is the abscissa and an absolute value (V) of the memory potential in the electrophotographic photoconductor having the intermediate layer is the ordinate. It means that the smaller the absolute value (V) of the memory potential, the better the generation of residual charges in the photosensitive layer is controlled and the better the generation of memory images can be prevented. The constitution of the electrophotographic photoconductor used and the method of measuring the memory potential are disclosed in Examples described below.

As understood from the fact that the characteristic curve is an upward convex curve, the absolute value (V) of the memory potential changes critically with increase in the value of the volume resistivity (Ω·cm) in the intermediate layer.

More specifically, it is found that when the value of the volume resistivity (Ω·cm) in the intermediate layer increases from 1×10⁶ Ω·cm to 1×10¹⁰ Ω·cm, the absolute value (V) of the memory potential decreases rapidly from about 40 V to about 20 V; while on the other hand, when the value of the volume resistivity (Ω·cm) in the intermediate layer is within the limits of 1×10¹⁰ to 5×10¹³ Ω·cm, the absolute value (V) of the memory potential is maintained stably at a low value near 15 V. It is also found that when the value of the volume resistivity (Ω·cm) in the intermediate layer is above 5×10¹³ Ω·cm, the absolute value (V) of the memory potential increases rapidly.

It is therefore found that the exposure memory can be stably controlled at a low value by setting the volume resistivity in the intermediate layer to a value within the range of 1×10¹⁰ to 5×10¹³ Ω·cm.

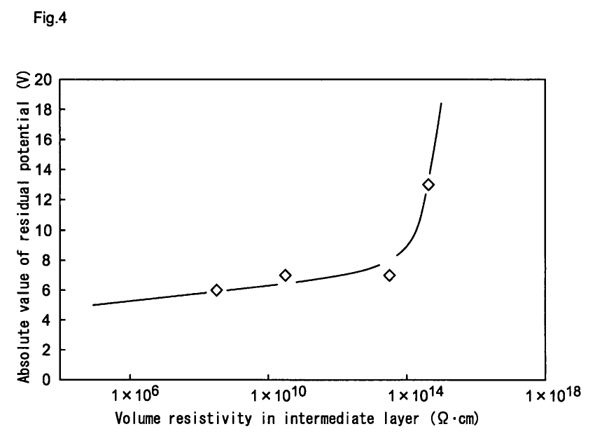

Next, the relationship between the volume resistivity in an intermediate layer and the residual potential in an electrophotographic photoconductor having the intermediate layer will be described with reference to FIG. 4.

In FIG. 4 shown is a characteristic curve (produced under conditions: average primary particle diameter of a titanium oxide in the intermediate layer=10 nm; thickness of the intermediate layer=2 μm) in which the volume resistivity (Ω·cm) in the intermediate layer is the abscissa and an absolute value (V) of the residual potential in the electrophotographic photoconductor having the intermediate layer is the ordinate. The smaller the absolute value (V) of the residual potential, the greater the surface potential difference between the electrostatic latent images formed by exposure and the nonexposed portion becomes, so that clear images can be formed. The constitution of the electrophotographic photoconductor used and the method of measuring a residual potential are disclosed in Examples described below.

As understood from the characteristic curve, the absolute value (V) of the residual potential increases with increase in the value of the volume resistivity (Ω·cm) in the intermediate layer.

More specifically, in a range where the value of the volume resistivity (Ω·cm) in the intermediate layer is up to 5×10¹³ Ω·cm, the absolute value (V) of the residual potential increases very slowly with increase in the value of the volume resistivity and values of about 8 V or less are maintained stably. It is found that when the value of the volume resistivity (Ω·cm) in the intermediate layer is above 5×10¹³ Ω·cm, on the other hand, the absolute value (V) of the residual potential increases rapidly, especially to about 14 V when the volume resistivity is about 5×10¹⁴ Ω·cm.

It is therefore found that the residual potential can be stably controlled at a low value by setting the volume resistivity in the intermediate layer to a value up to 5×10¹³ Ω·cm.

### (5) Film Thickness

It is characterized in that the thickness of the intermediate layer is set to a value within the range of 0.5 to 3 μm.

The reason is that by setting the thickness of the intermediate layer to the predetermined range, it is possible to adjust the electroconductivity of the overall intermediate layer to a preferable range in association with the volume resistivity in the intermediate layer disclosed above.

In other words, that is because when the thickness of the intermediate layer is below 0.5 μm, a leakage current generates between the base body and the photosensitive layer regardless of the volume resistivity in the intermediate layer, with the result that black spots are generated easily in formed images; while on the other hand, when the thickness of the intermediate layer is above 3 μm, the transfer efficiency of charges generated in the photosensitive layer may decrease over a long period of time even if the volume resistivity in the intermediate layer is small. As a result, residual potential may increase through carrier trap in the photosensitive layer or through increase in charges accumulated in the interface between the intermediate layer and the photosensitive layer.

For such reasons, it is more desirable to set the thickness of the intermediate layer to a value within the range of 0.8 to 2.5 μm, and even more desirably to a value within the range of 1 to 2 μm.

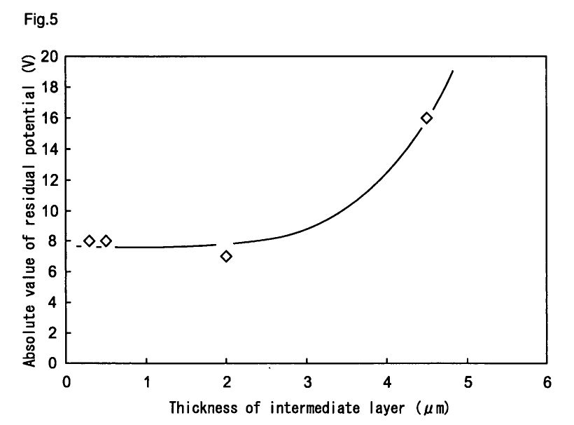

Next, with reference to FIG. 5, description will be given to the relationship between the thickness of the intermediate layer and the residual potential in the electrophotographic photoconductor having the intermediate layer.

In FIG. 5 shown is a characteristic curve (produced under conditions: average primary particle diameter of a titanium oxide in the intermediate layer=10 nm; content of a titanium oxide based on 100 parts by weight of the binding resin in the intermediate layer=100 parts by weight) in which a thickness (μm) of the intermediate layer is the abscissa and an absolute value (V) of the residual potential in the electrophotographic photoconductor having the intermediate layer is the ordinate. The constitution of the electrophotographic photoconductor used and the method of measuring a residual potential are disclosed in Examples described below.

As understood from the characteristic curve, the absolute value (V) of the residual potential increases with increase in the value of the thickness (μm) of the intermediate layer.

More specifically, in a range where the value of the thickness (μm) of the intermediate layer is up to 3 μm, the absolute value (V) of the residual potential is maintained almost at a fixed level regardless of increase in the value of the thickness, and values of about 8 V or less are maintained stably. It is found that when the value of the thickness (μm) of the intermediate layer is above 3 μm, on the other hand, the absolute value (V) of the residual potential increases rapidly, especially to about 17 V when the thickness is about 4.5 μm.

It is therefore found that the residual potential can be stably controlled at a low value by setting the thickness of the intermediate layer to a value up to 3 μm.

### (6) ΔL Value (According to JIS Z-8722)

It is preferable to set a value (ΔL value) obtained by subtracting an L value measured by using the base body alone from an L value of the intermediate layer measured in a state where the layer is arranged on the base body (a parameter value measured with the calorimeter in accordance with JIS Z-8722) to a value within the range of −5.0 to 0.

The reason is that the dispersibility of a titanium oxide in the intermediate layer can be easily checked by setting the ΔL value to a value within such a range, with the result of more easy and accurate control of the electroconductivity in the intermediate layer.

In other words, that is because when the ΔL value is below −5.0, it is shown that the lightness in the base body has decreased too much due to interposition of the intermediate layer, and such an excessive decrease in lightness means that the dispersibility of a titanium oxide has decreased too much.

That is also because when the dispersibility of a titanium oxide deteriorates too much, the electroconductivity of the intermediate layer may become nonuniform, so that it may become difficult to control the increase in exposure memory or residual potential effectively.

For such reasons, the ΔL value is more desirably to a value within the range of −4.0 to 0, and even more desirably to a value within the range of −3.0 to 0.

The ΔL value can be measured in the following manner.

That is, an L value (L₁) for the light having a wavelength of 550 nm in a base body having thereon an intermediate layer (standard thickness: 2 μm) is measured with a calorimeter (for example, CM 1000 manufactured by Minolta Co., Ltd.). Subsequently, an L value (L₂) for the light having a wavelength of 550 nm in a base body with no intermediate layer is measured in the same manner.

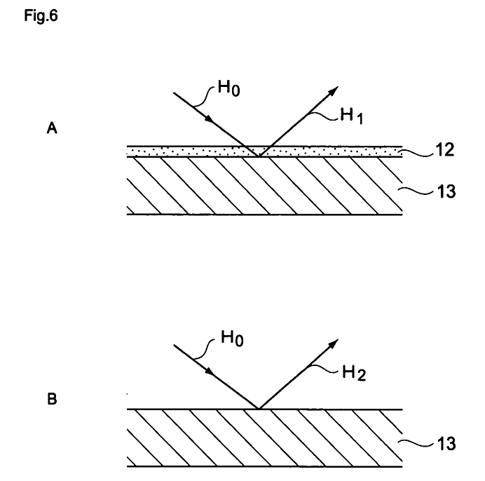

More specifically, a description will be made with reference to FIGS. 6A and 6B. FIG. 6A shows a state where the intermediate layer 12 is arranged on the base body 13, and FIG. 6B shows a state including only a base body. Each H₀ in FIGS. 6A and 6B expresses the light applied to the base body (incident light), and H₁ and H₂ each express the reflected light of the incident light applied to each base body.

Therefore, in order to determine an L value (ΔL value) in the intermediate layer by eliminating the influence of the base body, a corrected value may be obtained by subtracting the L value (L₂) of H₂ of the base body alone from the L value (L₁) of H₁ in which the reflected lights from the intermediate layer and the base body are mixed.

Namely, a corrected L value (ΔL value) of the intermediate layer can be calculated from the following numerical formula (1) based on the L values (L₁ and L₂) obtained.

ΔL=L₁−L₂ (1)

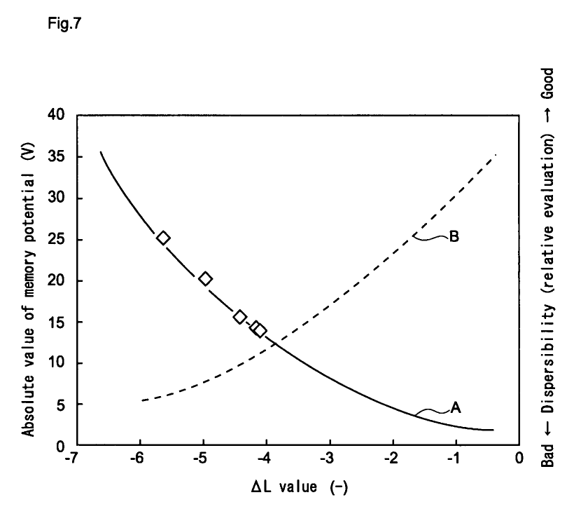

Next, the relationship between the dispersibility of a titanium oxide in an intermediate layer and the exposure memory in the electrophotographic photoconductor will be described with reference to FIG. 7.

The ΔL value mentioned above is used as the index of the dispersibility.

FIG. 7 includes a characteristic curve A in which the ΔL value (−) is the abscissa and the absolute value (V) of the memory potential in the electrophotographic photoconductor is the left ordinate, and a characteristic curve B in which the dispersibility (relative evaluation) of the titanium oxide in the intermediate layer is the right ordinate.

The relative evaluation of the dispersibility of the titanium oxide in the intermediate layer is evaluation based on the result of the microscopic observation of the intermediate layer.

First, as understood from the characteristic curve B, the dispersibility (relative evaluation) of the titanium oxide in the intermediate layer improves with increase in ΔL value.

In other words, it is shown that the greater the ΔL value, the higher the dispersibility of the titanium oxide in the intermediate layer is.

Therefore, it can be said that the dispersibility of the titanium oxide in the intermediate layer be evaluated clearly using a ΔL value.

As understood from the characteristic curve A, the absolute value of the memory potential decreases with increase in the ΔL value.

More specifically, it is found that when the ΔL value is below −5.0, the absolute value of the memory potential is a high value of 20 V or more; whereas when the ΔL value is −5.0 or greater, the absolute value of the memory potential can be maintained stably at low values which are not higher than 20 V.

Therefore, evaluating the results of the characteristic curves A and B collectively, it can be said that generation of exposure memory can be inhibited more effectively by improving the dispersibility of the titanium oxide in an intermediate layer through adjustment of the ΔL value to a predetermined range.

It has been confirmed that increase in the residual potential can also be controlled effectively by setting the ΔL value to a predetermined range.

### 3. Charge Generating Layer

### (1) Charge Generating Agent

### (1)-1 Kind

As the charge generating agent in the present invention, conventionally known charge generating agents can be used. Examples thereof include organic photoconductors including a phthalocyanine pigment such as metal-free phthalocyanine and oxotitanyl phthalocyanine, a perylene pigment, a bisazo pigment, a dioketo-pyrrolopyrrole pigment, a metal-free naphthalocyanine pigment, a metal naphthalocyanine pigment, a squaraine pigment, a trisazo pigment, an indigo pigment, an azulenium pigment, a cyanine pigment, a pyrylium pigment, an anthanthrone pigment, a triphenylmethane pigment, an indanthrene pigment, a toluidine pigment, a pyrazoline pigment and a quinacridone pigment; and inorganic photoconductors including selenium, selenium-tellurium, selenium-arsenic, cadmium sulfide and amorphous silicon.

More specifically, phthalocyanine pigments represented by the following formulas (1) to (4) (CGM-A to CGM-D) are preferred.

The reason is that an electrophotographic photoconductor having a sensitivity in a wavelength range from 600 to 800 nm or more is necessary when an image forming apparatus having a digital optical system, such as a laser beam printer, a facsimile, etc. provided with a semiconductor laser as a light source, is used.

On the other hand, when using an image forming apparatus having an analog optical system, such as an electrostatic copying machine provided with a white light source such as a halogen lamp, an electrophotographic photoconductor having sensitivity in the visible region is needed. In such cases, a perylene pigment, a bisazo pigment, and the like can suitably be used.

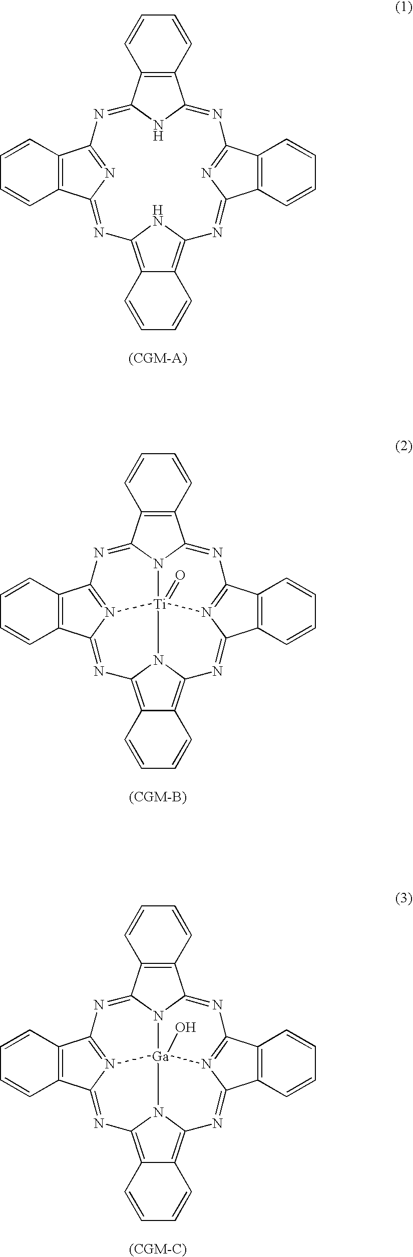

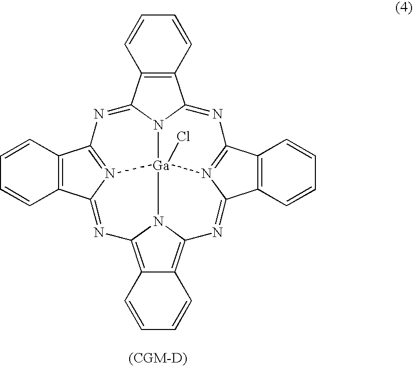

### (1)-2 Content

It is preferable to set the content of the charge generating agent to a value within the range of 5 to 1000 parts by weight based on 100 parts by weight of the binding resin constituting the charge generating layer.

The reason is that when the content is below 5 parts by weight based on 100 parts by weight of the binding resin, charges may be generated in an insufficient quantity and, as a result, it may become difficult to form clear electrostatic latent images; while on the other hand, when the content is above 1000 parts by weight based on 100 parts by weight of the binding resin, it may become difficult to form a uniform charge generating layer.

It is therefore preferable to set the content of the charge generating agent to a value within the range of 30 to 500 parts by weight based on 100 parts by weight of the binding resin constituting the charge generating layer.

### (2) Binding Resin

Examples of the binding resin used for the charge generating layer include polycarbonate resins, such as those of bisphenol A type, bisphenol Z type, or bisphenol C type, a polyester resin, a methacrylic resin, an acrylic resin, a polyvinyl chloride resin, a polystyrene resin, a polyvinyl acetate resin, a styrene-butadiene copolymer resin, a vinylidene chloride-acrylonitrile copolymer resin, a vinyl chloride-vinyl acetate-maleic anhydride resin, a silicone resin, a silicone-alkyd resin, a phenol-formaldehyde resin, a styrene-alkyd resin, and an N-vinylcarbazole, which may be used alone or in combination thereof.

### (3) Thickness

It is preferable to set the thickness of the charge generating layer to a value within the range of 0.1 to 5 μm.

The reason is that by setting the thickness of the charge generating layer to a value within the range of 0.1 to 5 μm, it is possible to increase the amount of charges generated by exposure.

In other words, that is because when the thickness of the charge generating layer is below 0.1 μm, it may become difficult to form a charge generating layer having a sufficient charge generating ability, while on the other hand, when the thickness of the charge generating layer is above 5 μm, it may become difficult to control the generation of residual charges or it may become difficult to form a uniform charge generating layer.

For such reasons, it is more desirable to set the thickness of the charge generating layer to a value within the range of 0.15 to 4 μm, and even more desirably to a value within the range of 0.2 to 3 μm.

### 4. Charge Transfer Layer

### (1) Charge Transfer Agent

### (1)-1 Kind

Examples of the charge transfer agent (hole transfer agent and electron transfer agent) used for the charge transfer layer include hole transfer materials including oxadiazole derivatives such as 2,5-bis(p-diethylaminophenyl)-1,3,4-oxadiazole, pyrazoline derivatives such as 1,3,5-triphenyl-pyrazoline and 1-(pyridyl-(2))-3-(p-diethylaminostyryl)-5-(p-diethylaminos tyryl)pyrazoline, aromatic tertiary amino compounds such as triphenylamine, tri(p-methyl)phenylamine, N,N-bis(3,4-dimethylphenyl)biphenyl-4-amine, and dibenzylaniline, aromatic tertiary diamino compounds such as N,N′-diphenyl-N,N′-bis(3-methylphenyl)-(1,1-biphenyl)-4,4′-diamine, 1,2,4-triazine derivatives such as 3-(4′-dimethylaminophenyl)-5,6-di-(4′-methoxyphenyl)-1,2,4-triazine, hydrazone derivatives such as 4-diethylaminobenzaldehyde-1,1-diphenylhydrazone, quinazoline derivatives such as 2-phenyl-4-styrylquinazoline, benzofuran derivatives such as 6-hydroxy-2,3-di(p-methoxyphenyl)-benzofuran, α-stilbene derivatives such as p-(2,2-diphenylvinyl)-N,N-diphenylaniline, enamine derivatives, carbazole derivatives such as N-ethylcarbazole, and poly-N-vinylcarbazole and its derivatives; electron transfer materials including quinone compounds such as chloranil, bromanil, and anthraquinone, tetracyanoquinodimethane compounds, fluorenone compounds such as 2,4,7-trinitrofluorenone and 2,4,5,7-tetranitro-9-fluorenone, xanthone compounds, thiophene compounds, and diphenoquinone compounds; and polymers having groups composed of the above-mentioned compounds at their main chains or side chains, which may be used alone or in combination thereof.

### (1)-2 Additional Amount

It is preferable to set the additional amount of the charge transfer agent to a value within the range of 10 to 100 parts by weight based on 100 parts by weight of the binding resin.

This is because if the additional amount of the charge transfer agent is below 10 parts by weight, the sensitivity is reduced and problems in practical use may arise, while on the other hand, if the additional amount of the charge transfer agent is a value greater than 100 parts by weight, the charge transfer agent crystallizes easily and a proper film may not be formed.

Therefore, it is more preferable to set the additional amount of the charge transfer agent to a value within the range of 20 to 80 parts by weight.

Note that although it is common to use, as a charge transfer agent, either a hole transfer agent or an electron transfer agent according to the charging property of an electrophotographic photoconductor, a hole transfer agent and an electron transfer agent may also be used together.

### (2) Additives

For the purpose of preventing deterioration of a photoconductor due to ozone or oxidizing gas generating in an electrophotographic machine, it is preferable to add antioxidants, light stabilizers, heat stabilizers and the like to the photosensitive layer.

Available examples of the antioxidants include hindered phenols, hindered amines, paraphenylenediamine, arylalkanes, hydroquinone, spirochroman, spiroindanone, derivatives thereof, organic sulfur compounds and organic phosphorus compounds. Examples of the light stabilizers include derivatives of benzophenone, benzotriazole, dithiocarbamate, and tetramethylpiperidine.

### (3) Binding Resin

As the binding resin for constituting the charge transfer layer, various resins conventionally used for forming photosensitive layers can be used.

For example, available resins include thermoplastic resins such as a polycarbonate resin, a polyester resin, a polyallylate resin, a styrene-butadiene copolymer, a styrene-acrylonitrile copolymer, a styrene-maleic acid copolymer, an acrylic copolymer, a styrene-acrylic acid copolymer, polyethylene, an ethylene-vinyl acetate copolymer, chlorinated polyethylene, polyvinyl chloride, polypropylene, ionomer, avinylchloride-vinylacetatecopolymer, analkydresin, polyamide, polyurethane, polysulfone, adiallylphthalate resin, a ketone resin, a polyvinyl butyral resin and a polyether resin; crosslinkable thermosetting resins such as a silicone resin, an epoxy resin, aphenol resin, a urea resin and amelamine resin; and photo-curing resins such as epoxy-acrylate and urethane-acrylate.

These binding resins may be used alone or after the blending or copolymerization of two or more of them.

### (4) Thickness

It is generally preferable to set the thickness of the charge transfer layer to a value within the range of 5 to 50 μm. This is because when the thickness of the charge transfer layer is below 5 μm, it may become difficult to apply it uniformly, while on the other hand, when the thickness of the charge transfer layer is above 50 μm, the mechanical strength may deteriorate. Therefore, it is more desirable to set the thickness to a value within the range of 10 to 40 μm.

### 5. Manufacturing Method

### (1) Preparation of Base Body

For preventing the generation of interference fringes, it is preferable to carry out a surface-roughening process on the surface of the supporting base body using any of methods including etching, anodizing, wet-blasting, sand-blasting, rough-cutting, and centerless-cutting.

### (2) Surface Treatment of a Titanium Oxide

As a method for applying surface treatment to titanium oxide, it is desirable to use, for example, a dry process in which the surface treatment of a titanium oxide is carried out by mixing and dispersing alumina, silica, an organosilicon compound and a titanium oxide with a pulverizer without using a solvent.

It is also desirable to use a wet process for performing the surface treatment of the titanium oxide in such a manner that alumina, silica and an organosilicon compound dissolved in a proper solvent is added to a titanium oxide slurry, and the mixture is stirred, followed by drying.

Comparing the dry process and the wet process, the wet process is preferred because it can achieve surface treatment uniform to a higher degree.

In the wet process, a wet media dispersion type machine is preferably used.

The reason is that such a wet media dispersion type machine is of excellent dispersing performance and, therefore, uniform surface treatment can be applied while effectively pulverizing and dispersing aggregated particles of the titanium oxide.

The wet media dispersion type machine as used herein is a machine that is filled with media and has a component which can increase the dispersion force, such as a stirring disc rotatable at a high speed.

As the media mentioned above, use of balls, beads, or the like is desirable. In order to achieve surface treatment to a higher degree, use of beads is preferred.

Alumina, glass, zircon, zirconia, steel, front stone and the like are suitably used as the raw material of the beads.

It is preferable to set the diameter of beads to a value within the range of 0.3 to 2 mm.

### (3) Formation of Intermediate Layer

### (3)-1 Preparation of Coating liquid for Forming Intermediate Layer

In forming an intermediate layer, it is preferable to add the aforementioned titanium oxide and a hole transfer agent or other additives to a solution with a resin component dissolved therein and, thereafter, to perform dispersing treatment so as to form a coating liquid.

Although the method of performing the dispersing treatment is not particularly limited, it is preferable to use a publicly-known method such as a roll mill, a ball mill, a vibration ball mill, an Attritor, a sand mill, a colloid mill, or a paint shaker.

In manufacturing the coating liquid for an intermediate layer, it is preferable to dissolve the binding resin in a plurality of stages and mix it with the aforementioned titanium oxide.

More specifically, the manufacturing of the coating liquid for an intermediate layer preferably includes the following steps (A) and (B):

(A) a step of adding titanium oxide to a binding resin solution in which the binding resin in an amount of 31 to 65% by weight of the total quantity of all the binding resin which constitutes the intermediate layer is dissolved, thereby forming a primary dispersion liquid; and

(B) a step of dissolving a binding resin in an amount of 35 to 69% by weight of the total quantity of all the binding resin in the primary dispersing liquid, thereby forming a coating liquid for an intermediate layer.

The reason is that, when the overall quantity of the binding resin, the overall quantity of the titanium oxide and the organic solvent are mixed in one step without dividing into a plurality of steps, a contact ratio of surfaces of the titanium oxide particles to the resin and a contact ratio of the surfaces of the titanium oxide particles to the organic solvent easily become non-uniform. Therefore, the characteristics of the surface of the titanium oxide in the coating liquid for an intermediate layer may change and hence, the dispersibility of the titanium oxide may deteriorate.

Further, when the mixing is performed in one step, especially, when titanium oxide having an average primary particle diameter is equal to or less than 15 nm, the dispersibility of the titanium oxide may remarkably deteriorate.

On the other hand, when the two steps (A) and (B) are provided in the manufacture of the coating liquid for an intermediate layer, the concentration of the titanium oxide in the primary dispersing liquid is extremely elevated first in the step (A), and hence, it is possible to easily make uniform the contact ratios of the surfaces of individual titanium oxide particles with the resin and the contact ratios of the surfaces of the individual titanium oxide particles with the organic solvent. Therefore, in the subsequent step (B), the dispersibility of the titanium oxide is to be kept in a fixed state even when the total quantity of binding resin is added. As a result, the storage stability of the coating liquid for an intermediate layer is improved and hence, it is possible to form a predetermined intermediate layer easily and stably.

Therefore, it is more preferable to set the quantity of the binding resin which is added in step (A) to an amount corresponding to 35 to 60% by weight, even more preferably 40 to 55% by weight, of the total quantity of the binding resin.

### (3)-2 Method of Applying Coating liquid for Intermediate Layer

Although the method of applying the coating liquid for an intermediate layer is not particularly limited, application methods such as an immersion coating method, a spray coating method, a bead coating method, a blade coating method, and a roller coating method may be used.

To form an intermediate layer and a photosensitive layer on the intermediate layer in a more stable manner, it is preferable to perform a heating and drying treatment for 5 minutes to 2 hours at a temperature of 30 to 200° C. after the application of the coating liquid for an intermediate layer.

### (4) Formation of Charge Generating Layer

### (4)-1 Preparation of Coating liquid for Charge Generating Layer

In the forming of a charge generating layer, a coating liquid is prepared by adding a charge generating agent and the like to a solution containing a resin component dissolved and then performing dispersing treatment.

Although the method of performing the dispersing treatment is not particularly limited, it is preferable to perform dispersion and mixing by use of a publicly-known device such as a roll mill, a ball mill, an Attritor, a paint shaker and a ultrasonic dispersing machine to produce a coating liquid.

### (4)-2 Application of Coating liquid for Charge Generating Layer

Although the method of applying a coating liquid for a charge generating layer is not particularly restricted, it is preferable to use, for example, a spin coater, an applicator, a spray coater, a bar coater, a dip coater, or a doctor blade.

It is preferable to perform drying using a high-temperature dryer or a vacuum dryer, for example, at a drying temperature of 60° C. to 150° C. in a drying step after the application step.

### (5) Formation of Charge Transfer Layer

Preferably, a charge transfer layer is formed in such a manner to produce a coating liquid by adding a charge transfer agent and the like to a solution with a resin component dissolved therein. Descriptions of the dispersing treatment, coating method and drying method are omitted here because the corresponding descriptions have been made for the charge generating layer.

### 6. Monolayer-type Electrophotographic Photoconductor

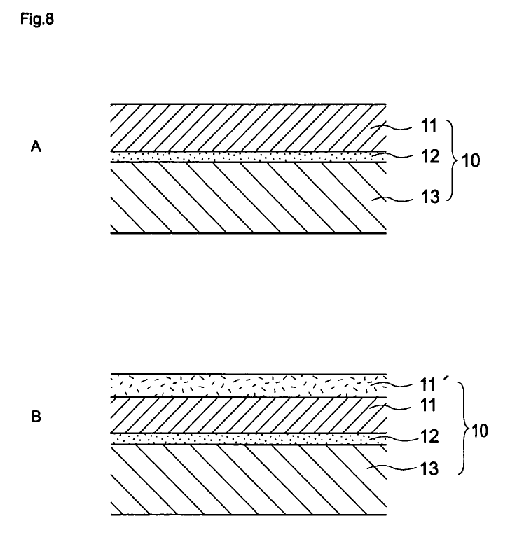

In constituting an electrophotographic photoconductor of the present invention, the photosensitive layer is preferred to be a monolayer-type electrophotographic photoconductor 10 comprising a supporting base body 13, an intermediate layer 12 and a photoconductor layer 11 as illustrated in FIG. 8A.

It is also preferable to provide a protective layer 11′ on the photosensitive layer 11 as shown in FIG. 8B.

Also in a monolayer-type electrophotographic photoconductor, an intermediate layer can be formed in conditions and method the same as those for a multilayer-type electrophotographic photoconductor. The photosensitive layer provided on the intermediate layer can be formed as follows. A coating liquid for a photosensitive layer is prepared by dispersing and mixing a charge generating agent, a charge transfer agent, a binding resin, and the like similar to those used for forming a multilayer-type electrophotographic photoconductor together with a dispersion medium. The prepared coating liquid is applied to an intermediate layer, followed by drying.

It is desirable to set the content of the charge generating agent in the photosensitive layer of such a monolayer type to a value within the range of 0.1 to 50 parts by weight, and more desirably to a value within the range of 0.5 to 30 parts by weight based on 100 parts by weight of the binding resin.

It is preferable to set the content of the hole transfer agent to a value within the range of 1 to 120 parts by weight, and more desirably to a value within the range of 5 to 100 parts by weight based on 100 parts by weight of the binding resin.

Like the hole transfer agent, it is preferable to set the content of the electron transfer agent to a value within the range of 1 to 120 parts by weight, and more preferably to a value within the range of 5 to 100 parts by weight based on 100 parts by weight of the binding resin.

It is preferable to set the thickness of the photosensitive layer to a value within the range of 5.0 to 100 μm, and more desirably to a value within the range of 10 to 80 μm.

### Second Embodiment

A second embodiment of the present invention is an image forming apparatus including any of the electrophotographic photoconductors described in the first embodiment and also including charging means, exposure means, developing means and transfer means arranged around the electrophotographic photoconductor.

Hereinafter, descriptions will be made mainly to points different from the descriptions of the first embodiment.

### 1. Basic Constitution

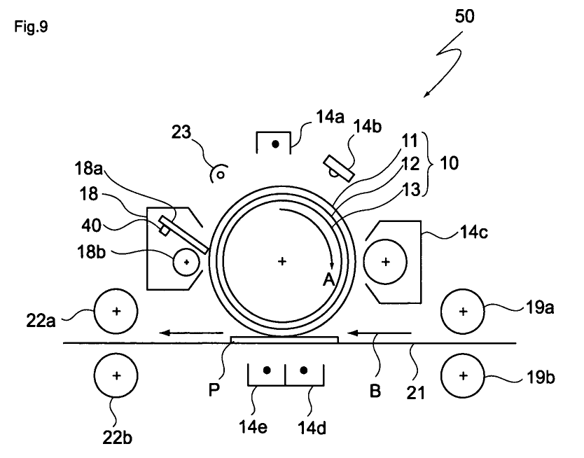

FIG. 9 shows the basic constitution of an image forming apparatus 50 according to the second embodiment of the invention. The image forming apparatus 50 is provided with a photoconductor 10 in a drum form. Around the electrophotographic photoconductor 10, a primary charger 14a, an exposure device 14b, a developing device 14c, a transfer charger 14d, a separating charger 14e, a cleaning device 18 and a discharger 23 are allocated one by one along the rotation direction indicated by arrow A. An electricity neutralizing means less system in which the discharger by light 23 is omitted is also available.

A recording material P is conveyed sequentially from the upstream along the conveying direction shown by arrow B by feed rollers 19a and 19b and a conveying belt 21. In the way, a fixing roller 22a and a pressing roller 22b for fixing toner to form an image are provided.

Electrophotographic photoconductor 10 has the above-mentioned predetermined intermediate layer 12 on a supporting base body 13. Therefore, the intermediate layer is a layer having a uniform thickness and the electrophotographic photoconductor can exhibit excellent electrical characteristics and image properties for a long period of time.

### 2. Operation

The basic operation of the image forming apparatus 50 will be described with reference to FIG. 9.

First, the electrophotographic photoconductor 10 of the image forming apparatus 50 is rotated in the direction shown by arrow A at a predetermined process speed (circumferential speed) with driving means (not shown) and the surface of the electrophotographic photoconductor 10 is charged to a predetermined polarity and potential with the primary charger 14a. For example, in a system in which a conductive elastic roller is brought into contact with the surface of a photoconductor, it is preferable to superimpose an alternating current voltage (AC) on a direct current voltage (DC).

Subsequently, light is applied to the electrophotographic photoconductor 10 with the exposure device 14b, such as a laser and an LED, through a reflecting mirror or the like under optical modulation depending on image information, thereby exposing the surface of the electrophotographic photoconductor to the light. This exposure enables an electrostatic latent image to be formed on the surface of the electrophotographic photoconductor 10.

Subsequently, a developer (toner) is developed with the developing device 14c based on the electrostatic latent image. Toner is contained in the developing device 14c. When a predetermined developing bias is applied to a developing sleeve attached, the toner adheres to the electrophotographic photoconductor 10 corresponding to the electrostatic latent image of the electrophotographic photoconductor 10, thereby forming a toner image.

Subsequently, the toner image formed on the electrophotographic photoconductor 10 is transferred to a recording material P. The recording material P is conveyed by the feed rollers 19a and 19b from a paper tray (not shown) and then it is fed to a transfer section located between the electrophotographic photoconductor 10 and the transfer charger 14d while being synchronized with the toner image on the electrophotographic photoconductor 10. The toner image on the electrophotographic photoconductor 10 can be transferred certainly on the recording material P by applying a predetermined transfer bias to the transfer charger 14d.

The recording material P to which the toner image has been transferred is then separated from the surface of the electrophotographic photoconductor 10 with the separating charger 14e and is conveyed to a fixing device by the conveying belt 21. Here, the recording material P is subjected to heat treatment and pressure treatment with the fixing roller 22a and pressing roller 22b to form a toner image on the surface of the recording material P. Then, the recording material P is discharged with discharge rollers (not shown) to the outside of the image forming apparatus 50.

On the other hand, the electrophotographic photoconductor 10 continues to rotate after the transfer of the toner image. The residual toner (adhered matter) which has not been transferred to the recording material P during the transfer process is removed from the surface of the electrophotographic photoconductor 10 with the cleaning device 18. The electrophotographic photoconductor 10 is used in the next image formation.

As described above, the electrophotographic photoconductor 10 can exhibit excellent electrical characteristics and image properties for a long period of time because it has the predetermined intermediate layer 12 on the base body 13.

### EXAMPLES

### The present invention will be described specifically with reference to examples, but the invention is not limited the contents thereof.

### 1. Coating liquid A for an Intermediate Layer

To a container, added were 75 parts by weight of the titanium oxide subjected to surface treatment with alumina and silica and subsequent surface treatment with methylhydrogenpolysiloxane (SMT-02 manufactured by TAYCA CORPORATION, number average primary particle diameter: 10 nm), 25 parts by weight of the titanium oxide subjected to surface treatment with alumina and silica (MT-05 manufactured by TAYCA CORPORATION, number average primary particle diameter: 10 nm), 300 parts by weight methanol, 75 parts by weight of butanol, and 50 parts by weight of Amilan CM8000 (quadri-polymer polyamide resin (molecular weight: 8000), manufactured by Toray Industries, Inc.) dissolved in advance in 100 parts by weight of methanol and 25 parts by weight of butanol. The mixture was mixed with a bead mill (media: zirconia balls of 0.5 mm in diameter) for 1 hour, yielding a primary dispersion liquid.

Subsequently, 50 parts by weight of Amilan CM8000 dissolved in advance in 100 parts by weight of methanol and 25 parts by weight of butanol was added, followed by secondary dispersion by stirring with a paint shaker for 1 hour. Thus, a coating liquid A for an intermediate layer (titanium oxide:binding resin=100:100) was obtained.

The addition quantities of the constituent materials in the coating liquid for an intermediate layer are based on the overall quantity of the Amilan CM8000 included in the coating liquid for an intermediate layer, which is used as a standard (100 parts by weight). This is also true for other coating liquids for an intermediate layer.

### 2. Coating liquid B for an Intermediate Layer

A coating liquid B for an intermediate layer (titanium oxide:binding resin=30:100) was prepared in the same manner as the coating liquid A for an intermediate layer except that the addition proportions of the titanium oxide, methanol and butanol based on 100 parts by weight of Amilan CM were changed to 0.3 times those in the case of the coating liquid A for an intermediate layer.

### 3. Coating liquid C for an Intermediate Layer

A coating liquid C for an intermediate layer (titanium oxide:binding resin=300:100) was prepared in the same manner as the coating liquid A for an intermediate layer except that the addition proportions of the titanium oxide, methanol and butanol based on 100 parts by weight of Amilan CM were changed to 3 times those in the case of the coating liquid A for an intermediate layer.

### 4. Coating liquid D for an Intermediate Layer

A coating liquid D for an intermediate layer (titanium oxide:binding resin=400:100) was prepared in the same manner as the coating liquid A for an intermediate layer except that the addition proportion of the titanium oxide based on 100 parts by weight of Amilan CM was changed to 4 times that in the case of the coating liquid A for an intermediate layer and that the addition proportions of methanol and butanol based on 100 parts by weight of Amilan CM were changed to twice those in the case of the coating liquid A for an intermediate layer.

### 5. Coating liquid E for an Intermediate Layer

A coating liquid E for an intermediate layer (titanium oxide:binding resin=300:100) was prepared in the same manner as the coating liquid C for an intermediate layer except that titanium oxide surface-treated with alumina and silica (manufactured by ISHIHARA SANGYO KAISHA, LTD., TTO-55A, number average primary particle diameter: 40 nm) was used as titanium oxide instead of SMT-02 and MT-05.

### 6. Coating liquid F for an Intermediate Layer

A coating liquid F for an intermediate layer (titanium oxide:binding resin=300:100) was prepared in the same manner as the coating liquid C for an intermediate layer except that titanium oxide surface-treated with alumina and silica (manufactured by TAYCA CORPORATION, MT-600SA, number average primary particle diameter: 50 nm) was used as titanium oxide instead of SMT-02 and MT-05.

### Example 1

### 1. Preparation of Multilayer-type Electrophotographic Photoconductor

### (1) Formation of Intermediate Layer

In Example 1, the coating liquid A for an intermediate layer was filtered through a 5-μm filter, and the resulting coating liquid for an intermediate layer was applied to an aluminum base body (supporting base body) having a diameter of 30 mm and a length of 238.5 mm by immersing the base body into the coating liquid at a rate of 5 mm/sec with one end of the base body up. Then, a curing treatment was performed at 130° C. for 30 min to form an intermediate layer of 0.5 μm in thickness.

### (2) Measurement of Volume Resistivity

The volume resistivity in the intermediate layer formed was measured.

That is, a gold electrode was formed by sputter deposition on the intermediate layer formed. Subsequently, a volume resistivity in the intermediate layer was measured by application of an electric field of 10 V/μm using the gold electrode as a − (minus) electrode and the base body as a + (plus) electrode.

More specifically, after cutting of the base body having thereon the intermediate into a 20 mm×20 mm fragment, the surface of the intermediate layer in the fragment was masked so that a 0.5 cm² opening was formed. Subsequently, a gold electrode was formed by sputter deposition using an ion sputtering device so that the thickness of the electrode became 40 nm.

As mentioned above, an electric field was applied between the gold electrode and the base body in the thus-formed sandwich cell and the electric current during the operation was measured. From the measurement, the volume resistivity of the intermediate layer was calculated.

In the following, an electrophotographic photoconductor was produced using a base body and an intermediate layer prepared in the same manner as the preparation of the base body and the intermediate layer used in the volume resistivity measurement.

### (3) Formation of Photosensitive Layer

Subsequently, 100 parts by weight of a polyvinyl acetal resin (S-LEC KS-5, manufactured by Sekisui Chemical Co., Ltd.) as a binder resin was mixed with 100 parts by weight titanylphthalocyanine prepared in the procedures described later as a charge generating agent and 6000 parts by weight of propylene glycol monomethyl ether and 2000 parts by weight of tetrahydrofran as dispersion media. The resulting mixture was subjected to dispersion for 48 hours using a ball mil to obtain a coating liquid for a charge generating layer.

The resulting coating liquid for a charge generating layer was filtered through a 3-μm filter, and the filtrate was applied to the intermediate layer by dip coating and dried at 80° C. for 5 min, forming a charge generating layer of 0.3 μm in thickness.

Subsequently, a coating liquid for a charge transfer layer was prepared by mixing and dissolving 100 parts by weight of a polycarbonate resin (TS2020, manufactured by TEIJIN CHEMICΔLS LTD.) as a binding resin, 70 parts by weight of a stilbene compound (HTM-1) represented by the following formula (5) as a hole transfer agent and 460 parts by weight of tetrahydrofuran as a solvent.

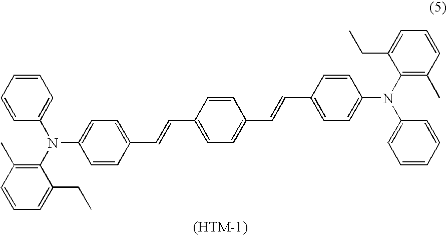

The resulting coating liquid for a charge transfer layer was applied to the charge generating layer in the same manner as the application of the coating liquid for a charge generating layer. It was then dried at 130° C. for 30 min to form a charge transfer layer of 20 μm in thickness, thereby obtaining a multilayer-type electrophotographic photoconductor.

The titanylphthalocyanine used was prepared in the following procedures.

First, 22 g of o-phthalonitrile, 25 g of titanium tetrabutoxide, 2.28 g of urea and 300 g of quinoline as raw materials for a reaction were added to a flask purged with argon. Then, the temperature was increased to 150° C. while the mixture was stirred with a stirrer.

Subsequently, the temperature was increased further to 215° C. while the vapor generating from the raw materials in the flask was distilled off. Then, while that temperature was maintained, the raw materials were allowed to react for additional 2 hours under stirring.

After the completion of the reaction, when the reaction product was cooled to 150° C., it was taken out of the flask and was separated with a glass filter. The resulting solid was washed with N,N-dimethylformamide and methanol successively, and then it was vacuum dried to yield 24 g of a bluish purple solid. (treatment before pigmentation)

Then, into a flask equipped with a stirrer, 10 g of the bluish purple solid and 100 ml of N,N-dimethylformamide were charged and heated to 130° C. Stirring treatment was continued for 2 hours to yield a reaction solution.

Subsequently, the heating was stopped and the solution was cooled to 23±1° C. and then left at rest for 12 hours, thereby being subjected to stabilizing treatment.

The reaction solution stabilized was separated with a glass filter and the resulting solid was washed with methanol. Subsequently, the solid was vacuum dried to yield 9.83 g of crude crystals of a titanylphthalocyanine compound.

Then, 5 g of the crude crystals of titanylphthalocyanine obtained and 100 ml of concentrated sulfuric acid were added to a flask with a stirrer and the crystals were dissolved homogeneously.

The resulting solution was dropped to water under ice-cooling and was stirred at room temperature for 15 minutes. The solution was then left at rest at 23±1° C. for 30 minutes to be recrystallized.

The recrystallized solution was separated with a glass filter and the solid collected was washed with water until the washings became neutral. The solid, containing water before drying, was then dispersed in 200 ml of chlorobenzene and the dispersion was heated to 50° C. and stirred for 10 hours.

The resulting solution was separated with a glass filter and the solid collected was vacuum dried at 50° C. for 5 hours, thereby obtaining 4.1 g of blue powder as titanylphthalocyanine crystals.

The titanylphthalocyanine obtained was confirmed that at the initial time and after a 7-day immersion in 1,3-dioxofuran or tetrahydrofuran, no peaks appeared at Bragg angle 2θ±0.2°=7.4° and 26.2° and that there was one peak at 296° C. other than a peak near 90° C. resulting from the evaporation of adsorbed water of adsorption.

### 2. Evaluation

### (1) Measurement of Residual Potential

A residual potential in the electrophotographic photoconductor obtained was evaluated using a drum sensitivity tester (manufactured by GENTEC Co.) as follows. Under the environment of a temperature of 20° C. and a humidity of 60%, the surface of the electrophotographic photoconductor was irradiated for 1.5 sec with monochromatic light having a wavelength of 780 nm (half value width: 20 nm, light intensity: 8 microW/cm²) isolated from white light of a halogen lamp through a band-pass filter while the electrophotographic photoconductor was charged to a surface potential of −700 V. Then, irradiation with 660 nm by neutralizing light (discharging light) was conducted for 1 second. Three seconds later, an absolute value of the surface potential was measured as an absolute value of a residual potential. This measurement result was evaluated in accordance with the following standard. The results are shown in Table 1.

### Good: The absolute value of the residual potential is below 10 V.

### Bad: The absolute value of the residual potential is 10 V or more.

### (2) Measurement of Memory Potential

The memory potential in the electrophotographic photoconductor obtained was evaluated.

Developing means was removed from an imaging unit of a printer (MICROLINE 5400 manufactured by Oki Data Corporation) adopting a negative charge reverse development process and a potential measuring device is mounted there to produce an imaging unit for potential measurement. The potential measuring device had a constitution in which a potential measuring probe was arranged to face the developing position section of the imaging unit. The potential measuring probe is arranged at the center in the axial direction of the electrophotographic photoconductor, and the distance between the potential measuring probe and the surface of the electrophotographic photoconductor was set to 5 mm.

Then, an electrophotographic photoconductor with which 10,000 sheets were printed using a 1% manuscript under an ordinary temperature and ordinary humidity environment (temperature: 23° C., relative humidity: 50% RH) was mounted in the imaging unit for potential measurement. To the electrophotographic photoconductor of the first rotation (95 mm long), an exposure corresponding to 65 mm of a solid black image was applied (exposed portion), and no exposure was applied to the remaining 30 mm portion (nonexposed portion). Subsequently, no exposure was applied also to the entire portion of the electrophotographic photoconductor in the second rotation. Then, a surface potential V0b (V) in the second rotation of the portion corresponding to the exposed portion of the first rotation and a surface potential V0 (V) in the second rotation of the portion corresponding to the nonexposed portion of the first rotation were measured. The absolute value of the potential difference |V0-V0b| (V) was calculated and used as an exposure memory (V). The results are shown in Table 1.

### (3) Evaluation of Memory Image

The memory image was evaluated using the electrophotographic photoconductor obtained.

The electrophotographic photoconductor produced was installed in a printer (Microline5400, manufactured by Oki Data Corporation), and then text images were printed repeatedly on 100,000 sheets under high-temperature and high-humidity conditions (temperature: 35° C., relative humidity: 85%). Subsequently, halftone images were continuously printed. On the other hand, also under low-temperature and low-humidity conditions (temperature: 10° C., relative humidity: 20%), text images were printed on 100,000 sheets, followed by continuous printing of halftone images. Whether some text images as residual images were generated in halftone images printed under the respective conditions were evaluated in accordance with the following standards. The results are shown in Table 1.

### Good: No residual images of test images were recognized in the halftone image.

### Fair: Residual images, which were indiscernible from text images, were recognized in the halftone image.

### Bad: Clear residual images of test images were recognized in the halftone image.

### (4) Evaluation of Black Spot Generation

Using the electrophotographic photoconductor obtained, generation of black spots during image formation was evaluated.

The electrophotographic photoconductor produced was installed in a printer (Microline 5400, manufactured by Oki Data Corporation), and 5,000 sheets were printed under high-temperature and high-humidity conditions (40° C., 90% RH) Subsequently, white printing was applied to a A4-size paper and the number of the black spots generated (spots/sheet) was counted. The results are shown in Table 1. The evaluation tests were carried out as mandatory tests under tough environments.

### (5) Evaluation of Adhesion

Using the electrophotographic photoconductor obtained, the adhesion on the photosensitive layer was evaluated.

The photosensitive layer (charge generating layer and charge transfer layer) of the obtained electrophotographic photoconductor was cut with a retractable knife to form 5×5 lattice cells sized 3 mm×3 mm (25 cells in total). The intermediate layer underlying the charge generating layer was maintained without being cut with the retractable knife.

Subsequently, a cellophane tape was stuck on the cells formed and was peeled off. Then, the adhesion between the photosensitive layer and the intermediate layer was evaluated in accordance with the following standards. The results are shown in Table 1.

### Good: No peeling of a photosensitive layer was recognized.

### Bad: Peeling of a photosensitive layer was recognized.

### Example 2

In Example 2, the volume resistivity in an intermediate layer was measured and an electrophotografic photoconductor was produce and evaluated in the same manner as in Example 1 except for changing the thickness of the intermediate layer to 2 μm. The results are shown in Table 1.

### Examples 3 and 4

In Examples 3 and 4, the volume resistivity in an intermediate layer was measured and an electrophotografic photoconductor was produce and evaluated in the same manner as in Example 1 except that the coating liquid C for an intermediate layer was used as a coating liquid for an intermediate layer and that the thickness of the intermediate layer was changed to 0.5 μm and 2 μm, respectively, as shown in Table 1. The results are shown in Table 1.

### Comparative Examples 1 to 4

In Comparative Examples 1 to 4, the volume resistivity in an intermediate layer was measured and an electrophotografic photoconductor was produce and evaluated in the same manner as in Example 1 except that the coating liquid B for an intermediate layer was used as a coating liquid for an intermediate layer and that the thickness of the intermediate layer was changed to 0.3 μm, 0.5 μm, 2 μm and 4.5 μm, respectively, as shown in Table 1. The results are shown in Table 1.

### Comparative Examples 5 and 6

In Comparative Examples 5 and 6, the volume resistivity in an intermediate layer was measured and an electrophotografic photoconductor was produce and evaluated in the same manner as in Example 1 except that the thickness of the intermediate layer was changed to 0.3 μm and 4.5 μm, respectively, as shown in Table 1. The results are shown in Table 1.

### Comparative Examples 7 and 8

In Comparative Examples 7 and 8, the volume resistivity in an intermediate layer was measured and an electrophotografic photoconductor was produce and evaluated in the same manner as in Example 3 except for changing the thickness of the intermediate layer to 0.3 μm and 4.5 μm, respectively, as shown in Table 1. The results are shown in Table 1.

### Comparative Examples 9 to 11

In Comparative Examples 9 to 11, the volume resistivity in an intermediate layer was measured and an electrophotografic photoconductor was produce and evaluated in the same manner as in Example 1 except that the coating liquid D for an intermediate layer was used as a coating liquid for an intermediate layer and that the thickness of the intermediate layer was changed to 0.6 μm, 2 μm and 4.5 μm, respectively, as shown in Table 1. The results are shown in Table 1.

### Comparative Examples 12 and 13

In Comparative Examples 12 and 13, the volume resistivity in an intermediate layer was measured and an electrophotografic photoconductor was produce and evaluated in the same manner as in Example 1 except that the coating liquid E for an intermediate layer was used as a coating liquid for an intermediate layer and that the thickness of the intermediate layer was changed to 0.6 μm and 2 μm, respectively, as shown in Table 1. The results are shown in Table 1.

### Comparative Examples 14 and 15

In Comparative Examples 14 and 15, the volume resistivity in an intermediate layer was measured and an electrophotografic photoconductor was produce and evaluated in the same manner as in Example 1 except that the coating liquid F for an intermediate layer was used as a coating liquid for an intermediate layer and that the thickness of the intermediate layer was changed to 0.6 μm and 2 μm, respectively, as shown in Table 1. The results are shown in Table 1.

TABLE 1

| | Intermediate layer | | | | | | | | | | |
|---|---|---|---|---|---|---|---|---|---|---|---|
| | Titanium oxide | | | | | | | | | | |
| | | Average | | | | Evaluation | | | | | |
| | | primary | | | | | | Number | | | |
| | | particle | Additional | | Volume | Memory | | of black | Residual potential | | |
| | | diameter | amount (parts | Thickness | resistivity | potential | Memory | spots | Potential | | |
| | Kind | (nm) | by weight) | (μm) | (Ω · cm) | (V) | image | (spots) | (V) | Result | Adhesion |
| Example 1 | SMT-02/ | 10 | 100 | 0.5 | 2.57 × 10¹³ | 13 | Good | 0 | 8 | Good | Good |
| Example 2 | MT-05 | | 100 | 2.0 | 3.23 × 10¹³ | 14 | Good | 0 | 7 | Good | Good |
| Example 3 | | | 300 | 0.5 | 3.03 × 10¹⁰ | 14 | Good | 0 | 8 | Good | Good |
| Example 4 | | | 300 | 2.0 | 3.23 × 10¹⁰ | 16 | Good | 0 | 7 | Good | Good |
| Comparative | | | 30 | 0.3 | 3.51 × 10¹⁴ | 21 | Fair | 1 | 15 | Bad | Bad |
| Example 1 | | | | | | | | | | | |
| Comparative | | | 30 | 0.5 | 3.52 × 10¹⁴ | 23 | Fair | 0 | 14 | Bad | Bad |
| Example 2 | | | | | | | | | | | |
| Comparative | | | 30 | 2.0 | 4.23 × 10¹⁴ | 24 | Fair | 0 | 13 | Bad | Bad |
| Example 3 | | | | | | | | | | | |
| Comparative | | | 30 | 4.5 | 5.07 × 10¹⁴ | 21 | Fair | 0 | 16 | Bad | Bad |
| Example 4 | | | | | | | | | | | |
| Comparative | | | 100 | 0.3 | 2.37 × 10¹³ | 15 | Good | 3 | 8 | Good | Good |
| Example 5 | | | | | | | | | | | |
| Comparative | | | 100 | 4.5 | 2.71 × 10¹³ | 15 | Good | 0 | 16 | Bad | Good |
| Example 6 | | | | | | | | | | | |
| Comparative | | | 300 | 0.3 | 1.57 × 10¹⁰ | 14 | Good | 2 | 8 | Good | Good |
| Example 7 | | | | | | | | | | | |
| Comparative | | | 300 | 4.5 | 2.71 × 10¹⁰ | 15 | Good | 0 | 17 | Bad | Good |
| Example 8 | | | | | | | | | | | |
| Comparative | | | 400 | 0.6 | 1.57 × 10⁸ | 21 | Fair | 2 | 8 | Good | Good |
| Example 9 | | | | | | | | | | | |
| Comparative | | | 400 | 2.0 | 3.23 × 10⁸ | 23 | Fair | 0 | 6 | Good | Good |
| Example 10 | | | | | | | | | | | |
| Comparative | | | 400 | 4.5 | 2.71 × 10⁸ | 21 | Fair | 0 | 18 | Bad | Good |
| Example 11 | | | | | | | | | | | |
| Comparative | TT0-55A | 40 | 300 | 0.6 | 1.97 × 10¹⁰ | 24 | Bad | 0 | 7 | Good | Good |
| Example 12 | | | | | | | | | | | |
| Comparative | | | 300 | 2.0 | 3.83 × 10¹⁰ | 28 | Bad | 0 | 8 | Good | Good |
| Example 13 | | | | | | | | | | | |
| Comparative | MT-600SA | 50 | 300 | 0.6 | 2.05 × 10¹⁰ | 34 | Bad | 0 | 9 | Good | Good |
| Example 14 | | | | | | | | | | | |
| Comparative | | | 300 | 2.0 | 3.25 × 10¹⁰ | 36 | Bad | 0 | 12 | Bad | Good |
| Example 15 | | | | | | | | | | | |

### INDUSTRIAL APPLICABILITY

The electrophotographic photoconductor of the present invention and the image forming apparatus using the same have made it possible to effectively prevent the generation of exposure memory and the increase in residual potential through easy adjustment of the electroconductivity in the intermediate layer by setting the average primary particle diameter of the titanium oxide dispersed in the intermediate layer, the thickness of the intermediate layer and the volume resistivity in the intermediate layer to predetermined ranges, respectively.

Therefore, the electrophotographic photoconductor of the invention and the image forming apparatus using the same are expected to greatly contribute to improvement in electrical characteristics in various image forming apparatuses such as copying machines and printers and to quality improvement of formed images.

What is claimed is:

1. An electrophotographic photoconductor comprising: a base body; and an intermediate layer containing a titanium oxide and a binding resin and a photosensitive layer which are arranged on the base body, wherein an average primary particle diameter of the titanium oxide is set to a value within the range of 5 to 30 nm, a thickness of the intermediate layer is set to a value within the range of 0.5 to 3 μm, and a volume resistivity in the intermediate layer is set to a value within the range of 1×10¹⁰ to 5×10¹³ Ω·cm.

2. The electrophotographic photoconductor according to claim 1, wherein a value (ΔL value) obtained by subtracting an L value measured by using the base body alone from an L value of the intermediate layer measured in a state where the layer is arranged on the base body (a parameter value measured with the calorimeter in accordance with JIS Z-8722) is set to a value within the range of −5.0 to 0.

3. The electrophotographic photoconductor according to claim 1, wherein the additional amount of the titanium oxide is set to a value within the range of 150 to 350 parts by weight based on 100 parts by weight of the binding resin.

4. The electrophotographic photoconductor according to claim 1, wherein surface treatment with alumina, silica and an organosilicon compound is applied to the titanium oxide.

5. The electrophotographic photoconductor according to claim 1, wherein the surface treatment amount with the alumina and silica is set to a value within the range of 1 to 30 parts by weight based on 100 parts by weight of the titanium oxide and the surface treatment amount with the organosilicon compound is set to a value within the range of 1 to 15 parts by weight based on 100 parts by weight of the binding resin.

6. The electrophotographic photoconductor according to claim 1, two or more kinds of the titanium oxide are included as the titanium oxide.

7. The electrophotographic photoconductor according to claim 1, wherein the binding resin is a polyamide resin.

8. The electrophotographic photoconductor according to claim 1, wherein a number average molecular weight of the binding resin is set to a value within the range of 1,000 to 50,000.

9. The electrophotographic photoconductor according to claim 1, wherein a coating liquid for forming the intermediate layer is obtained by a production method comprising the following steps (A) and (B):
(A) a step of adding the titanium oxide to a binding resin solution in which the binding resin in an amount of 31 to 65% by weight of the total quantity of all the binding resin which constitutes the intermediate layer is dissolved, thereby forming a primary dispersion liquid; and
(B) a step of dissolving the binding resin in an amount of 35 to 69% by weight of the total quantity of all the binding resin in the primary dispersing liquid, thereby forming a coating liquid for an intermediate layer.

10. An image forming apparatus comprising the electrophotographic photoconductor according to claim 1, wherein a charging means, an exposure means, a developing means and a transfer means are arranged around the electrophotographic photoconductor.

11. The image forming apparatus according to claim 10, wherein the image forming apparatus is an electricity neutralizing means less image forming apparatus in which the electricity neutralizing means by light is omitted.
